(19) United States
(12) Patent Application Publication
(10) Pub. No.: US 2023/0161021 A1
(43) Pub. Date: May 25, 2023

(54) METHOD AND APPARATUS FOR DETERMINATION OF DIRECTION OF ARRIVAL ANGLE

(71) Applicant: NXP B.V., Eindhoven (NL)

(72) Inventors: Marco Jan Gerrit Bekooij, Empel (NL); Arie Geert Cornelis Koppelaar, Giessen (NL); Saif Alhasson, Munich (DE)

(21) Appl. No.: 18/048,132

(22) Filed: Oct. 20, 2022

(30) Foreign Application Priority Data
Nov. 23, 2021 (EP) 21210013.5

(51) Int. Cl. G01S 13/06

(52) U.S. Cl. CPC G01S 13/06

(57) ABSTRACT

An apparatus comprising a processor configured to:
receive an input dataset indicative of radar signals received at a plurality of antenna elements from a plurality of targets;
define a matrix, Ã, of direction-of-arrival-angle vectors representing an expected response of the radar signals from the target and comprising a function of a direction of arrival angle relative to the antenna elements and including antenna-imperfection-factors that represent the angle dependent effect of antenna imperfections;
define an objective function based on the input dataset and the matrix;
search for a set of the direction of arrival angles for each of the plurality of targets by the repeated evaluation of the objective function for a plurality of candidate matrices based on matrix A, wherein said set is derived from one of the candidate matrices of the plurality of candidate matrices that provides a maximum or minimum evaluation of the objective function.

### FIELD

The present disclosure relates to an apparatus and method for determining the directions of arrival angles for each of a plurality of targets in a dataset indicative of radar signals received at an antenna array. The disclosure also relates to a frequency-modulated-continuous-wave, FMCW, radar system configured to perform said method.

### BACKGROUND

Deterministic Maximum-Likelihood (DML) Direction-of-Arrival (DoA) estimation is a technique for determination of the directions of arrival angles of component radar signals reflected from each of a plurality of targets in radar signals received at a plurality of antenna elements. The antenna elements may be part of a FMCW radar.

### SUMMARY

According to an aspect of the disclosure we provide an apparatus comprising a processor configured to:
receive an input dataset, x, indicative of radar signals received at a plurality of antenna elements, wherein the radar signals have reflected from a plurality of targets;
define a matrix, Ã, formed of direction-of-arrival-angle vectors, an, comprising one for each one of the plurality of targets, each direction-of-arrival-angle vector representing an expected response at the plurality of antenna elements of the radar signals from the target with a predetermined amplitude and comprising a function of a direction of arrival angle relative to the plurality of antenna elements and including antenna-imperfection-factors, qₚ, one for each of the plurality of antenna elements, that represent the direction-of-arrival-angle dependent effect of antenna imperfections;
define an objective function based on x and Ã;
search for a set of the direction of arrival angles for each of the plurality of targets by the repeated evaluation of the objective function for a plurality of candidate matrices based on matrix A that each include different direction-of-arrival-angle vectors over a search space, wherein said set of direction of arrival angles are derived from one of the candidate matrices of the plurality of candidate matrices that provides one of a maximum and a minimum evaluation of the objective function over the search space; and
wherein said search space comprises a plurality of discrete points associated with the direction of arrival angle.

In one or more embodiments, the antenna-imperfection-factors, qₚ, comprise: qₚ=qₚ(θₙ)e^{jh}^{ₚ}^{(θ}^{ₙ}⁾ wherein qₚ(θₙ) represents an angle dependent gain error caused by the antenna imperfections and hₚ(θₙ) represents an angle dependent phase error caused by the antenna imperfections and wherein n designates an index to step through the direction of arrival angles of the search space and wherein p comprises an index that designates each of the N antenna elements.

In one or more examples, each direction-of-arrival-angle vector of the matrix Ã includes one of said antenna-imperfection-factors to account for antenna imperfections for each one of the plurality of antenna elements.

In one or more embodiments, the apparatus is configured to, prior to said search for the set of direction of arrival angles, determine a first look up table, said first look up table providing an association between each of the plurality of discrete points of the search space and a function \tilde{F}ₖ, wherein \tilde{F}ₖ=\tilde{a}^{H}(eₖ)x and \tilde{a}^{H}(θₖ) comprises a Hermitian transpose of the direction-of-arrival-angle vector, ã, for a candidate direction of arrival angle θₖ having index k; and
wherein said search comprises a step of retrieving \tilde{F}ₖ from the look up table for each of the targets being evaluated for evaluating the objective function, wherein the objective function is based on the expression, \tilde{ƒ}:

\tilde{ƒ}=(Ã^{H}x)^{H}(Ã^{H}Ã)⁻¹(Ã^{H}x)

and \tilde{F}ₖ comprises part of the evaluation of the term (Ã^{H}x) of said expression, \tilde{ƒ}.

In one or more embodiments, the apparatus is configured to determine \tilde{F}ₖ by performing a correlation comprising calculating an inner product between direction-of-arrival-angle vector, \tilde{a}, and the input dataset, x, to obtain a complex value expression, wherein the first look up table comprises the evaluation of the complex value expression over the search space.

In one or more embodiments, the apparatus is configured to perform said correlation by calculation of dot products.

In one or more embodiments, the direction-of-arrival-angle vectors are of the form:

\tilde{a}ₖ^{T}=(q₁e^{j2π(d}^{₁}^{/λ)sin θ}^{ₖ},q₂e^{j2π(d}^{₂}^{/λ)sin θ}^{ₖ}, . . . ,q_{N}e^{j2π(d}^{_{N}}^{/λ)sin θ}^{ₖ})

for index k and the antenna-imperfection-factors are represented by qₚ wherein p comprises an index for the plurality of antenna elements.

In one or more embodiments, the apparatus is configured to, prior to said search for the set of direction of arrival angles, determine a second look up table, said second look up table providing an evaluation of ã_{k,n}=(\tilde{a}^{H}(θₖ)\tilde{a}(θₙ))/N wherein \tilde{a}^{H}(θₖ) comprises a Hermitian transpose of the direction-of-arrival-angle vector for candidate direction of arrival angle θₖ, and \tilde{a}(θₙ) comprises the direction-of-arrival-angle vector for a candidate direction of arrival angle θₙ, wherein k represents an index for each of the discrete points of the search space for a first target of the plurality of targets and n represents an index for each of the discrete points of the search space for a second target of the plurality of targets; and

wherein said search comprises a step of retrieving ã_{k,n} from the second look up table for evaluating the objective function, wherein the objective function is based on the expression, \tilde{ƒ}:

\tilde{ƒ}=(Ã^{H}x)^{H}(Ã^{H}Ã)⁻¹(Ã^{H}x)

and wherein the term (Ã^{H}Ã)⁻¹ is determined based on:

$${( {\tilde{A}}^{H} \tilde{A} )}^{- 1} = \frac{1}{N ( {\tilde{α}}_{k , k} {\tilde{α}}_{n , n} - {\vert {\tilde{α}}_{k , n} \vert}^{2} )} ( \begin{matrix}{\tilde{α}}_{n , n} & - {\tilde{α}}_{k , n}^{*} \\ - {\tilde{α}}_{k , n} & {\tilde{α}}_{k , k}\end{matrix} ) .$$

In one or more embodiments, the apparatus is configured to determine the second look up table based on the properties ã_{k,n}=(ã_{n,k})*, such that the second look up table size for ã_{k,n} is ½N_{θ}(N_{θ}−1), wherein N_{θ} designates the number of discrete points in the search space.

In one or more embodiments, the objective function \tilde{ƒ} is based on \tilde{ƒ}=(Ã^{H}x)^{H}(Ã^{H}Ã)⁻¹(Ã^{H}x).

In one or more embodiments, the objective function \tilde{ƒ} comprises

$$\tilde{f} = \frac{1}{N ( {\tilde{α}}_{k , k} {\tilde{α}}_{n , n} - {\vert {\tilde{α}}_{k , n} \vert}^{2} )} ( \vert {\tilde{F}}_{k} \vert - 2 Re \{ {\tilde{α}}_{k , n} {\tilde{F}}_{k} {\tilde{F}}_{n}^{*} \} + {\vert {\tilde{F}}_{n} \vert}^{2} )$$

wherein \tilde{F}ₖ=\tilde{a}^{H}(θₖ)x and \tilde{F}ₙ=ã^{H}(θₙ)x, and ã_{k,n}=(\tilde{a}^{H}(θₖ)\tilde{a}(θₙ))/N, and ã_{k,k}=(ã^{H}(θₖ)\tilde{a}(θₖ))/N, and ã_{n,n}=(\tilde{a}^{H}(θₙ)\tilde{a}(θₙ))/N.

In one or more embodiments, the apparatus is configured to account for noise by application of a factor Λ^{1/2}ϕ^{T} to the matrix Ã wherein A is a diagonal matrix representing the spatial colouring comprising the variance of each noise component, and ϕ is the correlation between the noise components, such that the noise covariance matrix is Σ=ΛϕΛ⁻¹; wherein
the apparatus being configured to define the objective function comprises the apparatus being configured to define the objective function based on x and Λ^{1/2}ϕ^{T}Ã.

In one or more embodiments, the apparatus is configured to account for antenna coupling effects by application of a matrix M(θ) to the matrix A wherein matrix M(θ) is a predetermined matrix that is indicative of the effect the excitation of one of the plurality of antenna element will have on the signal measured with another of the plurality of antenna elements; and
wherein the apparatus being configured to define the objective function comprises the apparatus being configured to define the objective function based on x and M(θ).Ã.

In one or more embodiments, the apparatus includes a Range-Doppler processing module configured to separate antenna data into one or more datasets, each dataset representative of one or more targets and each dataset, relative to others of the one or more datasets, being representative of one or both of:
different ranges from the antenna elements; and
different radial velocities relative to the antenna elements; wherein the antenna data comprises radar signals received at the plurality of antenna elements that have reflected from the plurality of targets, and wherein the input dataset, x, comprises one of said one or more datasets separated by the Range-Doppler processing module.

In one or more embodiments, the apparatus comprises a frequency-modulated-continuous-wave, FMCW, radar system.

In one or more examples, said plurality of antenna elements are provided by a microstrip antenna. Thus, in one or more examples, said antenna elements may be formed by photolithographic techniques on a substrate.

According to a second aspect of the disclosure we provide a method for determining the directions of arrival angles for each of a plurality of targets K in radar signals comprising:
receiving an input dataset, x, indicative of radar signals received at a plurality of antenna elements wherein the radar signals have reflected from a plurality of targets;
defining a matrix, Ã, formed of direction-of-arrival-angle vectors, \tilde{a}ₙ, comprising one for each one of the plurality of targets, each direction-of-arrival-angle vector representing an expected response at the plurality of antenna elements of the radar signals from the target with a predetermined amplitude and comprising a function of the direction of arrival angle relative to the plurality of antenna elements and including antenna-imperfection-factors, qₚ, one for each of the plurality of antenna elements, that represent the direction-of-arrival-angle dependent effect of antenna imperfections;
defining an objective function based on x and Ã;
searching for a set of directions of arrival angles for each of the plurality of targets by the repeated evaluation of the objective function for a plurality of candidate matrices based on matrix Ã that each include different direction-of-arrival-angle vectors over a search space, wherein said set of directions of arrival angles are derived from one of the candidate matrices of the plurality of candidate matrices that provides one of a maximum and minimum evaluation of the objective function over the search space; and
wherein said search space comprises a plurality of discrete points associated with the direction of arrival angles.

According to an aspect of the disclosure we provide a computer program product, such as a non-transitory computer program product comprising computer program code which, when executed by a processor of an apparatus causes the apparatus to perform the method of the second aspect.

In one or more examples, the apparatus may comprise at least one processor and at least one memory, wherein the memory stores the computer program and the processor is configured to execute said computer program.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example embodiment of an apparatus and a FMCW system;

FIG. 2 shows an example embodiment of a pair of antenna elements illustrating a direction of arrival angle;

FIG. 3 shows an example embodiment of a plurality of antenna elements, wherein the antenna elements may be true antenna elements or virtual antenna elements or a combination;

FIG. 4 shows an example computer readable medium; and

FIG. 5 shows an example flowchart illustrating a method.

### DETAILED DESCRIPTION

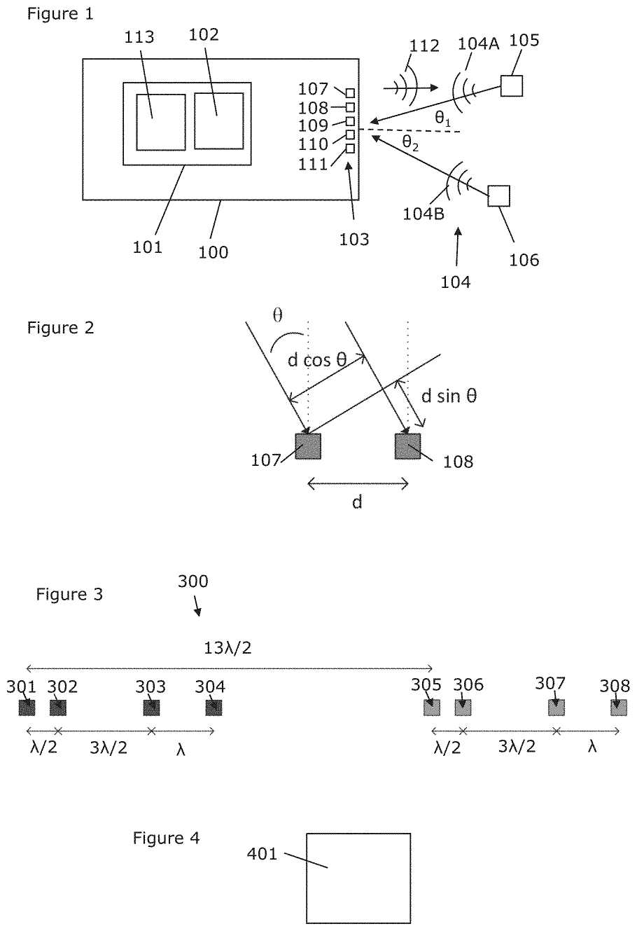

FIG. 1 shows an example embodiment of a FMCW system 100. The system comprises an apparatus 101, which may comprise a processor 102, for processing data indicative of radar signals 104 received by an antenna array 103. The radar signals 104 may comprise reflections from one or a plurality of targets 105, 106.

The antenna array 103 comprises a plurality of antenna elements 107-111. One or more of the antenna elements may be configured to transmit radar signals, which may comprise a FMCW chirp 112, that will reflect from the targets 105, 106. Two or more of the antenna elements 107-111 may be configured to receive the reflected radar signals 104A, 104B from the targets 105, 106. The antenna array 103 may be formed as a microstrip antenna and may therefore be printed on a substrate. In some examples, microstrip antennas are straightforward to manufacture but are known to exhibit imperfections in their phase and gain curves. However, it will be appreciated that the present method can account for imperfections that cause discrepancies in the measurement of direction-of-arrival angle using other antenna types.

FMCW radar has many applications and may be used in the automotive field to detect targets in the neighbourhood of the vehicle with the objective to make driving safer and more comfortable. Distance to the target(s) 105, 106 and the relative velocity of the target(s) can be estimated. The use of several antenna elements 107-111 to transmit and receive radar signals allows for the direction in which this target is present to be determined and it is typically represented as an angle relative to a direction of the antenna elements.

The reflected radar signal 104A from the first target 105 has a direction of arrival angle of θ₁ at the antenna elements 107-111. The reflected radar signal 104B from the second target 106 has a direction of arrival angle θ₂ at the antenna elements 107-111. However, the radar signals 104 as received by the antenna elements 107-111 comprises a combination of the signals 104A and 104B and noise. It will also be appreciated that the direction of arrival angle may represents the angle of arrival of the reflected radar signals 104A, 104B in one or both of an azimuth angle and an elevation angle.

Accordingly, it is necessary to processes the received radar signals to determine, optionally, the number of targets (if not known or otherwise determined) and the direction of arrival angles θₖ, which in this example comprise θ₁ and θ₂.

Deterministic Maximum-Likelihood (DML) Direction-of-Arrival (DoA) estimation is a known process for determining the most likely (including likely) angles from which the radar signals 104A, 104B are received to create the observed combination of radar signals 104 as received by the antenna elements 107-111.

The transmitted radar signals are reflected by the target(s) 105, 106 and received by the receive antenna elements of the radar system 100 and, depending on the direction of arrival angle of the reflected wave(s) θ₁ and θ₂, different pathlengths between transmit antenna element, targets 105, 106 and receive antenna elements are realised, leading to phase differences and amplitude differences in the received radar signals between the antenna elements. Analysis of these amplitude and phase differences is carried out to estimate the direction of arrival angle of the target(s).

Direction of arrival angle estimation based on data from the antenna array 103 is an important matter for radar systems 100. If the radar signals received originate from one target 105, the signal strength at the antenna elements 107-111 is identical but due to path length differences between antenna elements 107-111 and target 105 the phase of the radar signal will be different and is a function of the direction of arrival angle.

The use of microstrip antennas may introduce limitations in terms of achievable resolution and maximum allowable power-difference between targets when using the DML DoA estimation technique, as well as other DoA estimation techniques. These limitations may become even more pronounced when there are more than two targets that need to be detected. This could, in practical systems, limit the maximum number of directions-of-arrival that can be estimated to only two. Further, the DML technique, as well as other DoA estimation techniques, may only be effective if the targets have a reflected power difference of at most 10 dB.

Compensation of the imperfections is highly desirable but is complicated by the fact that the effect of the imperfections in the data received from the antenna array is DoA dependent. Therefore, the compensation that should be applied is unknown before the DoA is estimated, but accurate DoA estimation requires that compensation has already been applied. The apparatus and methods described in one or more examples, are configured to compensate for the imperfections as part of the DoA determination algorithm rather than by pre-processing, which may therefore reduce the complexity of the processing.

FIG. 2 shows two example antenna elements, which may comprise antenna elements 107 and 108 receiving the radar signal 104A. The path length difference is given by dsinθ where d is the antenna element spacing and θ is the direction-of-arrival angle.

When multiple targets 105, 106 are reflecting, a linear combination of these signals will be received. Because of the linear combination, both the amplitude and the phase per antenna element 107-111 will vary and has to be used to estimate the DoA angles of the targets 105, 106.

In practice the number of targets 105, 106 is unknown and has to be estimated as well. In one or more examples, data from the antenna array 103 can be pre-processed to analyse the space in which the targets are located.

Using radar signals, such as FMCW radar signals, one can use the known technique of Range-Doppler processing to quantize the received signal in Range and Doppler shift. For each Range-Doppler combination for which one has detected energy (above a threshold), one can carry out the DoA estimation. The Range-Doppler pre-processing separates targets on the basis of their distance from the antenna array 103 and their velocity (Doppler) and therefore the number of targets per Range-Doppler bin are expected to be low. The properties of the FMCW signal determine how fine the radar scene is quantized in Range and Doppler. With an appropriate designed radar system it is reasonable to assume that having one target present in the radar data of one Range-Doppler bin is more likely than having two present in the radar data of one Range-Doppler bin, and 2 targets more likely than 3 targets etc. In one or more examples, therefore, an algorithm to solve the DoA problem may therefore start with searching first for only one target, then for two targets, then for three targets, etc. When each of these searches indicates how well the found candidate DoA's match with the received radar data signals then one can stop searching for more targets if the match with the received signal is sufficiently close (e.g. above a threshold level of confidence). Noise in the radar system is a reason why an exact match is unlikely to happen. Since noise power is estimated in radar systems, a threshold may be derived to evaluate the match.

Deterministic Maximum Likelihood DoA estimation is a technique that for a given number of targets can determine what the most likely DoA angles are and what their match is to the received radar signal. In one or more examples, the DML algorithm may be configured to find the DoA angles that maximizes the match with the received radar data. In case a K-target search with DML finds a match that is too poor (e.g. below a threshold level of a match) on the basis of the known noise properties, then one proceeds with a (K+1)-target search with DML. A DML search for (K+1) targets is more complex than a search for K targets. Therefore, in a practical implementation one has to stop after a certain K because of limitations in computing resources to search for more targets. Moreover, system imperfections (amplitude and phase distortions, noise) also limits the number of targets one successfully can estimate. In one or more examples a practical value for K is therefore from 1 to 2 or 1 to 3 or 1 to 4 or 1 to 5 potential targets.

DoA estimation may be carried out for each Range-Doppler bin for which sufficient energy is detected. In a rich radar scene this means that DoA estimation may have to be carried out many times within a system cycle. For that reason it is important that the corresponding complexity of the DoA estimation process is low.

DoA estimation starts with the radar signals received at the antenna elements or, more particularly, the data representing the reflected radar signals received at the antenna elements 107-111. These signals can be represented collectively with an N-dimensional vector x=(x₁, . . . , x_{N})^{T}, which is often called a snapshot, and wherein T stands for transpose, such that x is a column vector. The snapshot thereby represents the received signals at a particular point in time at the antenna elements of the antenna array and may have been Range-Doppler processed, as will be described below. The number of antenna elements is N. During a system cycle, radar signals received by the apparatus 101 may comprise data representative of the received signals at each of the antenna elements 107-111. In one or more examples, during a system cycle, radar signals received by the apparatus may comprise snapshots extracted from one or more Range-Doppler bins. In one or more examples, DoA estimation may be carried out only for those Range-Doppler bins that contain radar signals having an energy above a certain threshold. Thus, the following process can be performed on the data whether or not Range-Doppler processing has been performed.

A signal received from a target at DoA angle 81 will result in a response at the antenna elements 107-111. That response has constant amplitude and a phase relation between the antenna elements that is specific for the DoA angle θ₁ and the relative positions of the antenna elements 107-111. The response can be denoted with a vector: a₁=a(θ₁). When at least two antenna elements have a distance ≤λ/2, and the DoA angle θ may be between −90 and 90 degrees, any two single target responses will be different and therefore the DoA angle of a single target response can be unambiguously determined. For multiple, say K targets, the antenna response will be a linear combination of K single target responses, i.e.

x=Σₖ₌₁^{K}sₖaₖ+n,

where n represents additive noise, and sₖ represent the complex amplitude of the targets and x represents an input dataset representing the radar signals received at the antenna elements 107-111, and aₖ comprises a vector and comprises a function of the DoA, wherein

aₖ^{T}=(e^{j2π(d}^{₁}^{/λ)sin θ}^{ₖ},e^{j2π(d}^{₂}^{/λ)sin θ}^{ₖ}, . . . ,e^{j2π(d}^{_{N}}^{/λ)sin θ}^{ₖ})

and (d₁, . . . ,d_{N}) are the relative positions of the antenna elements or virtual antenna elements. The vector aₖ carries the relative phase behaviour among the antenna elements due to pathlength difference of a planar wave originating from an angle θₖ. However, this representation of aₖ does not account for phase and gain deviations caused by antenna imperfections.

FIG. 3 shows an example microstrip antenna array 300 with antenna elements 301-308 separated by distances d of different fractions of the operating wavelength. For example, the antenna array 300 may be configured to operate according to a MIMO scheme for which the positions of the two virtual antenna elements 301, 305 are indicative of the positions of the transmitters and are separated by 13 λ/2, and the virtual antenna elements 301, 302, 303, 303 are indicative of the receive array with antenna spacing (0, 1, 4, 6)λ/2, that in this specific example forms a Minimum Redundancy Array. Together they form a virtual antenna array with relative element positions (d₁, . . . ,d₈)=(0, 1, 4, 6, 13, 14, 17, 19)λ/2. Thus, in one or more examples, the antenna array 300 may comprise a combination of true and virtual antenna elements depending on the configuration of the antenna array. In other examples, the antenna array 300 may comprise all true antenna elements, i.e. the scenario in which the radar system will use one transmitter 301 antenna and eight receive antennas 301-308. Thus, the term antenna element can refer to true (real) antenna elements as well as virtual antenna elements.

The processing performed by the apparatus is based on the aforementioned input dataset. The input dataset may be from a Range-Doppler bin if the optional Range-Doppler processing is performed.

A more formal way to describe the linear combination of K single target responses is: x=As+n, where s collectively contains the K complex amplitudes sₖ of the targets, n represents additive noise, and the matrix A contains the K single target responses aₖ, for k=1, . . . , K.

For Additive White Gaussian Noise (AWGN), it is known that the K-target DML estimation can be summarized for finding the value of s and the matrix A that minimizes:

Q=∥x−As∥₂²

The value for s and the matrix A that minimizes Q, are called the maximum likelihood (ML) solutions. Wherein ∥ ∥₂² represents a square of a 2-norm. For the DoA estimation problem, s is a side-product and the matrix A is the main output because its columns a can be uniquely linked to DoA angles θ.

This indicates that we rely on that linear superposition of the radar signals of the individual sources. This linear superposition principle is presumed to hold if imperfections are present and that therefore, imperfections are applied per source according to this model. Therefore, the imperfections can be included by replacing the matrix A with a matrix Ã(θ) in which the gain and phase imperfections are accounted for. Thus, Ã(θ) may include additional terms that account for antenna imperfections. Accordingly, the objective function that accounts for the antenna imperfections can be designated \tilde{Q}, rather than Q, and may be represented as follows:

\tilde{Q}=∥x−Ãs∥₂²

Wherein ∥ ∥₂² represents a square of a 2-norm.

Before we describe the methodology associated with the objective function \tilde{Q}, a general description of DML-DoA determination will be provided followed by embodiments of the processing that the example embodiment apparatus 100 is configured to perform.

Instead of jointly searching for the most likely s and the matrix A, an intermediate step may be carried out such that the search can be confined to the search for the most likely matrix A.

To simplify the search, it can be assumed that if one knows what the matrix A is, then given A and antenna response x then one can determine which value of s minimizes Q=∥x−As∥₂². This is a mean-square error problem and its least square solution is given by \hat{s}=(A^{H}A)⁻¹A^{H}x, where superscript H means complex conjugate transpose. The matrix (A^{H}A)⁻¹A^{H} is also known as the pseudoinverse or Moore-Penrose inverse and is then denoted by A⁺. To complete the simplification, the solution is substituted back into the expression for Q:

Q=x^{H}(I−A(A^{H}A)⁻¹A^{H})x=x^{H}x−x^{H}(A(A^{H}A)⁻¹A^{H})x.

Hence, the K-target DML problem becomes the problem of finding the K-column matrix A that minimizes Q. The term x^{H}x in the expression for Q stays constant for a given received antenna response, that is the input dataset x, and can therefore be omitted in the search for the most likely matrix A.

Instead of minimizing Q, one can equivalently perform a search with the aim of maximizing f, wherein:

ƒ=x^{H}(A(A^{H}A)⁻¹A^{H})x.

f is therefore an alternative objective function (rather than Q) of the search for A.

f as a function of A for a given antenna response x has many local maxima. The search for the most likely matrix A, i.e. the one that maximizes f, may or may not be performed exhaustively.

Also, if we define B as B=(A^{H}A)⁻¹, and y=A^{H}x so y^{H}=x^{H}A, f can be simplified to:

ƒ=x^{H}(A(A^{H}A)⁻¹A^{H})x=y^{H}(A^{H}A)⁻¹Y=y^{H}By

At this point let us define D as (A^{H}A), such that B=(A^{H}A)⁻¹=D⁻¹.

With Fₖ=aₖ^{H}x, which comprises a steering vector correlated with the snapshot, we have for y:

$$\underline{y} = [ \begin{matrix}{F}_{k} \\ {F}_{n}\end{matrix} ]$$

Another practical point of attention is that the DoA angles that lead to the formation of matrix A can have any value between −90 and 90 degrees. To limit the search space, the DoA search space may be quantized into N_{θ} discrete points in the range <−90,90> degrees. Hence per target we consider N_{θ} DoA angles.

A further simplification to the search may be performed. In particular, to further reduce the search space one has to realize that the function f is symmetric, i.e. for K=2 targets, the evaluation of the DML objective function f with A=[a(θ₁) a(θ₂)] provides the same result as using A=[a(θ₂) a(θ₁)]. Therefore, one can reduce the search space for K=2, with roughly a factor 2 without sacrificing the finding of the maximum. In general, for K targets, the search space can be limited to size N_{K}=

$${N}_{K} = ( \begin{matrix}{N}_{θ} \\ K\end{matrix} ) .$$

As an example, for N_{θ}=256 and a search for K=2 targets, the search space has an approximate size of 2¹⁵=32768. Hence, the DML objective function f has to be evaluated N_{K} times in order to find the K DoA angles that maximizes f.

As an example of a general DML algorithm, we provide the following summary:

```
• for n=1:N_{K},
  ○ select θ₁, θ₂, ..., 0k from DoA search space
  ○ form matrix A = (a(θ1) a(θ2) ... a(θ_{K})], matrix has K columns and
  N rows
  ○ Calculate A^{H}A, where H means complex conjugate transpose
    (Hermitian). The result is a KxK matrix
  ○ Determine B = (AHA)⁻¹, i.e. the inverse of A^{H}A
  ○ Premultiply B with A and postmultiply with A^{H}:
      ABA^{H} = A (A^{H}A)⁻¹ A^{H}, this is an NxN matrix
  ○ Use the antenna response input dataset x to calculate ƒ =
    x^{H}(A(A^{H}A)⁻¹A^{H})x
  ○ During search keep track of maximum f so far and the
    corresponding DoA angles
• End
```

The general DML algorithm suffers from a lot of intensive matrix operations per evaluation of the DML objective function for each point in the search space. Thus, with the DML process formulated as matrix algebra and with the use of a reasonably dense search space, it is clear that the process is computationally intensive.

In the summary above, the K-dimensional search is represented as a linear search. It will apparent to those skilled in the art that the K-dimensional search can also be represented as K nested for-loops. The matrix operations that makes DML computationally intensive would be carried out in the inner for-loop. The search space associated with the K nested for-loops has the same size as the linear search shown in the summary above, i.e. the search space has size N_{K}. In one or more examples, the complexity of the inner loop of the algorithm can be reduced if one confines to K=2 targets.

In one or more examples, the following known method may be performed to reduce the number of matrix operations in the inner loop. In this example, the same objective function f is calculated for all points in the direction-of-arrival search space, but the calculations are organized in a different way.

Firstly, it is observed that the DML objective function without loss of generality can be rewritten as ƒ=(x^{H}A)(A^{H}A)⁻¹(A^{H}x)=(A^{H}x)^{H}(A^{H}A)⁻¹(A^{H}x).

Secondly it is observed that the A^{H}x is the correlation of the antenna response input dataset x with the complex conjugate of K single target responses, i.e. A^{H}x=(a^{H}(θ₁)x,a^{H}(θ₂)x, . . . , a^{H}(θ_{K})x)^{T}.

Thirdly, for K=2, the matrix B=(A^{H}A)⁻¹ can be calculated symbolically such that no matrix inversion has to be carried out in the inner loop. With A=[a(θₖ)a(θₙ)] one obtains

$$B = {( {A}^{H} A )}^{- 1} = \frac{1}{N ( 1 - {\vert {α}_{k , n} \vert}^{2} )} ( \begin{matrix}1 & - {\tilde{α}}_{k , n}^{*} \\ - {\tilde{α}}_{k , n} & 1\end{matrix} ) , where$$

$${α}_{k , n} = \frac{1}{N} ( {\underline{a}}^{H} ( {θ}_{k} ) \underline{a} ( {θ}_{n} ) ) .$$

Note this is an in-product between 2 single target responses and results in complex scalar. This equation however only holds for an ideal antenna i.e. without imperfections. Combining all aforementioned steps, one can summarize the general DML method as follows:

```
• For k=1:N_{θ}
  ○ Select θₖ, form a(θₖ)
  ○ For n=k+1:N_{θ},
    ▪ Select θₙ, form a(θₙ)
    ▪ Calculate (or recall) α_{k,n} = (a^{H}(θₖ) a(θₙ))/N
    ▪ Calculate Fₖ = a^{H}(θₖ) x and Fₙ = a^{H}(θₙ) x
    ▪ Substitute the values for a_{k,n}, Fₖ and Fₙ in the expression for
      the DML objective function.
    ▪ $f = \frac{1}{N ( 1 - \vert {α}_{k , n} {\vert}^{2} )} ( {\vert {F}_{k} \vert}^{2} - 2 Re \{ {α}_{k , n} {F}_{k} {F}_{n}^{*} \} + {\vert {F}_{n} \vert}^{2} ) ,$
      where Re{ } means the real part.
    ▪ During search keep track of maximum f so far and the
      corresponding DoA angles
  ○ End
• End
```

It will be appreciated that in this example, the search may be decomposed into two nested for-loops. One for-loop for each of the two DoA angles θ₁ and θ₂ the search is looking to identify.

Embodiments of the inventive processes performed by the apparatus 100 will now be described. It will be appreciated that the method to reduce the number of (or remove) matrix operations in the inner loop are implemented in the processes described below. It will also be appreciated that the formulation of \hat{s} and the quantization of the search space as described above are also applied to the processes described below.

As mentioned previously, the objective function that accounts for the antenna imperfections can be designated \tilde{Q} and may be represented as follows:

\tilde{Q}=∥x−Ãs∥₂²

To summarise, the apparatus 101 comprising the processor 102 is configured to receive an input dataset, x, indicative of radar signals, x₁, . . . , x_{N}, received at a plurality of (real and/or virtual) antenna elements 107-111, 301-308, N, wherein the radar signals have reflected from a plurality of targets, namely K=2 targets 105, 106 in the example of FIG. 1. The input dataset may comprise a snapshot from a Range-Doppler bin after Range-Doppler processing has been performed. Otherwise the input dataset may be indicative of the radar signal received at the plurality of antenna elements 107-111, 301-308 without Range-Doppler processing. Thus, in one or more examples, the radar signals x₁, . . . ,x_{N} represent signals from N (i.e. virtual) antenna elements after Range Doppler processing. One such signal, say xₙ, may be a complex value, wherein its amplitude |xₙ| may represent the energy of the radar signal by means of energy being linear with |xₙ|². In one or more examples, Range-Doppler processing is done once per system cycle, hence the energy associated with xₙ may be the average for one system cycle and specific for one range, one Doppler value and one virtual antenna element. In one or more examples, only for those Range-Doppler values (the radar signals of the input dataset) for which sufficient energy is detected at the N antennas, the DoA estimation method described below is applied. It will be appreciated that determining “sufficient energy” may comprise a comparison to a threshold value. The threshold value may be set based on an assessment of noise in the radar signals.

The processor 102 is configured to define a matrix, Ã, formed of K vectors, \tilde{a}ₙ, comprising one for each one of the plurality of targets 105, 106, each vector a representing an expected response of the target represented by the vector with a predetermined amplitude and comprising a function of the direction of arrival angle relative to the plurality of antenna elements and also including a factor representing the antenna imperfections. Thus, it will be appreciated that the expected response may be considered the “reference” response of a target at direction of arrival angle theta without noise, wherein such a “reference” response is represented with a vector, and the direction of arrival information is contained in the phase and wherein the vectors are considered to include amplitude variations and phase errors due to antenna imperfections. Further, in practice, the true response of a target at direction of arrival angle theta will be scaled version of the vector \tilde{a} and will be additionally corrupted by additive noise. It will be appreciated that the number (K) of vectors \tilde{a} may be known by way of predetermined information. In other examples, K may initially be assumed to be one, then two and so on up to a predetermined maximum number and a search for the vectors \tilde{a}ₙ may be performed for each assumed K.

Thus, the matrix Ã comprises component vectors \tilde{a}ₙ for each target and as mentioned above, each of the vectors \tilde{a}ₙ may be represented as follows, wherein the transpose of aₙ is given by

\tilde{a}ₙ^{T}=(q₁e^{j2π(d}^{₁}^{/λ)sin θ}^{ₙ},q₂e^{j2π(d}^{₂}^{/λ)sin θ}^{ₙ}, . . . ,q_{N}e^{j2π(d}^{_{N}}^{/λ)sin θ}^{ₙ})

With qₚ=gₚ(θₙ)e^{jh}^{ₚ}^{(θ}^{ₙ}⁾ with gₚ(θₙ) being an angle dependent gain error caused by the antenna imperfections and hₚ(θₙ) being an angle dependent phase error caused by the antenna imperfections, p designating an index associated with stepping through the N antenna elements and wherein d₁, d₂ . . . d_{N} represents the relative positions of the antenna elements 107-111, 301-308 from a reference point. Thus, for example, the distance between a 1^{st} and 2^{nd} antenna element is d₂-d₁. Each vector of the matrix Ã includes a term qₚ to account for antenna imperfections.

The processor 102 is configured to define a signal amplitude vectors to represent expected complex amplitudes of each of the K targets as received in the radar signals. In one or more examples, the processor 102 is configured to define a noise vector representing noise present at the plurality of antenna that receive the radar signals. It will be appreciated that the definition of the noise vector is based on an assumption that we can model the system as having additive noise. The noise represented by the noise vector may be assumed to comprise Additive White Gaussian Noise.

The processor 102 is configured to define an objective function based on x, Ã and s. As mentioned above the objective function may comprise:

\tilde{Q}=∥x−Ãs∥₂², which can be expressed in a variety of ways, including with the substitution of \hat{s} as defined above, which is an estimate of the signal source vector s.

The processor 102 is configured to search for a set of directions of arrival angles, one for each of the K targets, by the repeated evaluation of the objective function for a candidate matrix Ã(θ) that include vectors that represent directions of arrival angles from the search space and the antenna imperfections, wherein said set of directions of arrival are derived from the candidate matrix A that provides a minimum evaluation of the objective function over the search space. It will be appreciated that a minimum evaluation of the objective function may be determined by a maximum evaluation of the objective function should it be expressed differently, although both achieve the same aim of finding a matrix Ã(θ) that sufficiently matches the input dataset x by virtue of the evaluation of the objective function reaching a minimum or maximum (depending on how it is expressed) or a value beyond a predetermined threshold. The definition of the search space determines which candidate values in the matrix A are evaluated in the search.

\tilde{Q}=∥x−Ãs∥²₂The determination of the objective function based on will now be described in more detail.

\tilde{Q}=∥x−Ãs∥₂²

As mentioned, the matrix Ã comprises column vectors \tilde{a}ₖ, wherein

Ã=[\tilde{a}ₖ,\tilde{a}ₙ]

With

\tilde{a}ₙ^{T}=(q₁e^{j2π(d}^{₁}^{/λ)sin θ}^{ₙ},q₂e^{j2π(d}^{₂}^{/λ)sin θ}^{ₙ}, . . . ,q_{N}e^{j2π(d}^{_{N}}^{/λ)sin θ}^{ₙ})

for candidate angle index n, and antenna-imperfection-factors or coefficients qₚ wherein p designates an index for the antenna elements and shown here as q₁ through to q_{N} for each of the N antenna elements.

Or

\tilde{a}ₖ^{T}=(q₁e^{j2π(d}^{₁}^{/λ)sin θ}^{ₖ},q₂e^{j2π(d}^{₂}^{/λ)sin θ}^{ₖ}, . . . ,q_{N}e^{j2π(d}^{_{N}}^{/λ)sin θ}^{ₖ})

for candidate angle index k, and antenna-imperfection-factors or coefficients qₚ wherein p designates an index for the antenna elements and shown here as q₁ through to q_{N} for each of the N antenna elements.

The Hermitian matrix of Ã is Ã^{H} which is defined below with ãₖ^{H} row vectors as:

$${\tilde{A}}^{H} = [ \begin{matrix}{\tilde{\underline{a}}}_{k}^{H} \\ {\tilde{\underline{a}}}_{n}^{H}\end{matrix} ]$$

Let us define \tilde{D}=Ã^{H}Ã, as mentioned above, where the tilde indicates a function of Ã rather than A.

Thus,

$$\tilde{B} = {\tilde{D}}^{- 1} = {( {\tilde{A}}^{H} \tilde{A} )}^{- 1} = \frac{1}{N ( {\tilde{α}}_{k , k} {\tilde{α}}_{m , n} - {\vert {\tilde{α}}_{k , n} \vert}^{2} )} ( \begin{matrix}{\tilde{α}}_{n , n} & - {\tilde{α}}_{k , n}^{*} \\ - {\tilde{α}}_{k , n} & {\tilde{α}}_{k , k}\end{matrix} ) ,$$

It will be appreciated that a tilde indicates a function of Ã (which includes the term q to account for antenna imperfections) rather than A (which assumes an ideal antenna).

A key difference with ã_{k,n} compared to a_{k,n} is that ã_{k,n} is different for all k and n whereas, in contrast, a_{k,n}=aₖ₋ₙ.

As explained above, the determination of the direction-of-arrival angles involves the determination of Fₖ. In the present apparatus 100, this expression includes the component vectors d of the matrix Ã and therefore the function is designated \tilde{F}, wherein \tilde{F}ₖ=\tilde{a}^{H}(θₖ)x.

Further, as described above in relation to the prior method that does not account for antenna imperfections, the DML objective function, expressed previously as f, may be expressed as \tilde{ƒ} with changes made to the terminology to represent where the terms are based on Ã rather than A as follows:

$$\tilde{f} = \frac{1}{N ( {\tilde{α}}_{k , k} {\tilde{α}}_{n , n} - {\vert {\tilde{α}}_{k , n} \vert}^{2} )} ( {\vert {F}_{k} \vert}^{2} - 2 Re \{ {\tilde{α}}_{k , n} {\tilde{F}}_{k} {\tilde{F}}_{n}^{*} \} + {\vert {\tilde{F}}_{n} \vert}^{2} ) ,$$

where Re{ } means the real part

The calculation of \tilde{F}ₖ=\tilde{a}^{H}(θₖ)x and \tilde{F}ₙ=\tilde{a}^{H}(θₙ)x is essentially the “beam- forming” correlation result at angles θₖ and θₙ with indexes k and n. Therefore, |Fₖ|² and |Fₙ|² are equal to the values of the “beam-forming” spectrum evaluated at angles θₖ and θₙ. The next observation is that the value ã_{k,n}=(\tilde{a}^{H}(θₖ)\tilde{a}(θₙ))/N is an inner product (or dot product) between two “reference” single target responses. Therefore, the DML objective function can be regarded as the sum of single target beam-forming spectra values that are corrected with a value that represents mutual influence of single target responses at the total antenna array response. E.g. when ã_{k,n}=0 (N.B. alpha_{k,n}), the single target responses are orthogonal and the DML objective function simply becomes \tilde{ƒ}=1/N(|\tilde{F}ₖ|²+|\tilde{F}ₙ|²).

Also for K>2 targets, the evaluation of the DML objective function can be written as a part in which the contribution of K targets is accounted for independently and a second part in which the mutual influence of the K targets is accounted for. This mutual influence is then still described by the same ã_{k,n}. For example, for three targets k, m, n we have mutual influence ã_{k,m}, ã_{k,n} and ã_{m,n}.

In one or more examples, the apparatus 101 is configured to, prior to said search for the set of directions of arrival angles, determine a first look up table, said look up table providing an association between each of the points in the search space (which relate to the plurality of discrete DoA angles) of the search space and a function \tilde{F}ₖ, wherein \tilde{F}ₖ=\tilde{a}^{H}(θₖ)x and \tilde{a}^{H}(θₖ) comprises a Hermitian transpose of the vector \tilde{a} for target k for a candidate direction of arrival angle θₖ; and

wherein said search comprises a step of retrieving one or more \tilde{F}ₖ values from the look up table for each of the targets being evaluated for evaluating an objective function that contains the expression:

\tilde{ƒ}=(Ã^{H}x)^{H}(Ã^{H}Ã)⁻¹(Ã^{H}x)

and \tilde{F}ₖ comprises part of the evaluation of the term (Ã^{H}x) of said objective function, \tilde{ƒ}.

Thus, as an example, in a two target evaluation, K=2, the apparatus 100 is configured to retrieve two values from the first look up table, say for candidate angle θₖ, \tilde{F}ₖ is retrieved and for the other candidate angle θₙ, \tilde{F}ₙ is retrieved (i.e. two candidates angles are jointly evaluated in expression, \tilde{ƒ}, comprising one candidate angle for the 1^{st} target and one candidate angle for the 2^{nd} target. Thus, (\tilde{F}ₖ, \tilde{F}ₙ)^{T} comprises the evaluation of the term (Ã^{H}x). Hence it can be considered that \tilde{F}ₖ comprises part of the evaluation of (Ã^{H}x), and \tilde{F}ₙ the other part of the evaluation of (Ã^{H}x).

The first look up table thus provides an evaluation of the function \tilde{F}ₖ for each Direction of Arrival angle θ associated with the search space. To summarize, in the search step for the best DoA angle, for each target we consider N_{θ} possible values for the DoA angle. For each of the N_{θ} DoA angles, one can determine a vector a that represents the “reference” (or normalized noise-less, but accounting for antenna imperfections) response for a single target from that DoA angle. The evaluation of the DML objective function requires (among more calculations) the evaluation of (Ã^{H}x), where Ã is constructed from K of these “reference” responses. The calculation of (Ã^{H}x), for a given radar signal x, can be determined for each of the N_{θ} candidate DoA angles. The N_{θ} calculations thus comprise the first look up table and, for example, the look up table will contain N_{θ} complex values, one complex value per candidate DoA angle.

In one or more examples, the first look up table also includes an evaluation of |\tilde{F}ₖ|² for each point in the search space.

In one or more examples, the apparatus 100 is configured to determine \tilde{F}ₖ by performing a correlation comprising calculating an inner product between direction-of-arrival-angle vector \tilde{a} and the input dataset x to obtain a complex value expression, wherein the look up table comprises the evaluation of the complex value expression over the search space, that is for each discrete point in the search space.

In one or more examples, the apparatus 100 is configured to perform said correlation by use of N_{Θ} dot products.

In one or more examples, the apparatus 100 is configured to, prior to said search for the set of directions of arrival angles, determine a second look up table, said second look up table providing an association between each of the candidate direction of arrival angles based on the discrete points of the search space for a plurality of targets, K, and ã_{k,n}, wherein ã_{k,n}=(\tilde{a}^{H}(θₖ)\tilde{a}(θₙ))/N wherein \tilde{a}^{H}(θₖ) comprises a Hermitian transpose of the vector \tilde{a} for a candidate direction of arrival angle θₖ, \tilde{a}(θₙ) comprises the vector for a different candidate direction of arrival angle θₙ for each target, wherein k and n represent indexes for stepping through the search space; and

wherein said search comprises a step of retrieving ã_{k,n} from the look up table for evaluating an objective function that contains the expression:

\tilde{ƒ}=(Ã^{H}x)^{H}(Ã^{H}Ã)⁻¹(Ã^{H}x)

and wherein the term (Ã^{H}Ã)⁻¹ is determined based on

$${( {\tilde{A}}^{H} \tilde{A} )}^{- 1} = \frac{1}{N ( {\tilde{α}}_{k , k} {\tilde{α}}_{m , n} - {\vert {\tilde{α}}_{k , n} \vert}^{2} )} ( \begin{matrix}{\tilde{α}}_{n , n} & - {\tilde{α}}_{k , n}^{*} \\ - {\tilde{α}}_{k , n} & {\tilde{α}}_{k , k}\end{matrix} )$$

The above relates to a situation of searching for K=2 targets. In a search for K=3 targets, it will be appreciated a third index m will be involved and the apparatus will be configured to recall ã_{k,m}, ã_{k,n} and ã_{m,n} from a look up table.

In a search for K=3 targets, it will be appreciated that a third index m will be involved. The 3×3 matrix (PA) is then given by:

$${( {\tilde{A}}^{H} \tilde{A} )}^{- 1} = N ( \begin{matrix}1 & {\tilde{α}}_{k , n} & {\tilde{α}}_{k , m} \\ {\tilde{α}}_{k , n} & 1 & {\tilde{α}}_{n , m} \\ {\tilde{α}}_{k , m} & {\tilde{α}}_{n , m} & 1\end{matrix} ) .$$

Accordingly, the matrix \tilde{B}=(Ã^{H}Ã)⁻¹ can be computed and expressed in terms of ã_{k,n}, ã_{k,m} and ã_{m,n}:

$$B = \frac{1}{N ( \begin{matrix}1 - {\vert {\tilde{α}}_{k , n} \vert}^{2} - {\vert {\tilde{α}}_{m , n} \vert}^{2} - {\vert {\tilde{α}}_{k , m} \vert}^{2} + \\ 2 Re \{ {\tilde{α}}_{k , n}^{*} {\tilde{α}}_{k , m} {\tilde{α}}_{n , m}^{*} \}\end{matrix} )} \cdot E wherein$$

$$E = ( \begin{matrix}1 - {\vert {\tilde{α}}_{n , m} \vert}^{2} & - ( {\tilde{α}}_{k , n} - {\tilde{α}}_{k , m}^{*} {\tilde{α}}_{n , m} ) & - ( {\tilde{α}}_{k , m}^{*} - {\tilde{α}}_{k , n}^{*} {\tilde{α}}_{n , m}^{*} ) \\ - ( {\tilde{α}}_{k , n} - {\tilde{α}}_{k , m} {\tilde{α}}_{n , m}^{*} ) & 1 - {\vert {\tilde{α}}_{k , m} \vert}^{2} & - ( {\tilde{α}}_{n , m}^{*} - {\tilde{α}}_{k , n}^{*} {\tilde{α}}_{k , m}^{*} ) \\ - ( {\tilde{α}}_{k , m} - {\tilde{α}}_{k , n} {\tilde{α}}_{n , m} ) & - ( {\tilde{α}}_{n , m} - {\tilde{α}}_{k , n} {\tilde{α}}_{k , m} ) & 1 - {\vert {\tilde{α}}_{k , m} \vert}^{2}\end{matrix} )$$

The correlation of the antenna response x with the complex conjugate of K single target responses is given by:

Ã^{H}x=(\tilde{a}^{H}(θₖ)x,\tilde{a}^{H}(θₙ)x,\tilde{a}^{H}(θₘ)x)^{T}=( [symbol] ,\tilde{F}ₙ,\tilde{F}ₘ)^{T}

In one or more examples, the apparatus 100 is configured to provide the second look up table based on the properties ã_{k,n}=(ã_{n,k})*, such that the second look up table size for ã_{k,n} is ½N_{θ}(N_{θ}+1), wherein N_{θ} designates the number of discrete points in the search space.

As mentioned above, Range-Doppler processing may or may not be performed to arrive at the input dataset. Accordingly, in one or more examples, the apparatus 101 includes a Range-Doppler processing module 113 configured to separate antenna data from the antenna elements 107-111, 301-308 into one or more datasets, at least one of the one or more datasets representative of one or more targets and each dataset, relative to others of the one or more datasets, being representative of one or both of:
different ranges from the antenna elements; and
different radial velocities relative to the antenna elements; wherein the antenna data comprises radar signals received at the plurality of antenna elements that have reflected from the plurality of targets, and wherein the input dataset, x, comprises one of said one or more datasets separated by the Range-Doppler processing module 113.

We now consider coloured noise and correlated noise. In the above example, the noise, n, was assumed to be uncorrelated and Gaussian distributed with the same variance. In one or more examples, the apparatus 100 may be configured to approximate the noise distribution with correlated coloured Gaussian distributed noise. In such one or more examples, the matrix Ã is replaced with a matrix \dot{A}, wherein \dot{A}=Λ^{1/2}ϕ^{T}Ã. In this equation, Λ is a diagonal matrix describing the spatial colouring (variance of each noise component) and ϕ is the correlation between the noise components, such that the noise covariance matrix is Σ=ΛϕΛ⁻¹, as will be familiar to those skilled in the art of whitening transformation.

We now consider antenna coupling effects. Antenna coupling is the effect that the excitation of one antenna will have an influence on the signal measured with another antenna because the EM-field is affected. There is also a parasitic capacitive coupling between antenna. The antenna coupling effects can be included in an angle dependent, antenna coupling matrix, which can be termed M.

In the case of N antenna elements, M is a N×N matrix, which can be dependent of DoA angle. The coupling effects (which can be considered leakage) can be represented with the inverse of the antenna coupling matrix (which has to be predetermined). In an ideal antenna there is no leakage and the antenna coupling matrix is the identity matrix. After undoing the coupling effect, one has caused correlation and colouring of the noise, but these can be compensated using a decorrelation matrix and a Gamma matrix (whitening matrix, has only diagonal elements).

The antenna coupling effects can be included in an angle dependent matrix M(θ) such that the snapshot x becomes x=M(θ). Ã(θ)s. The coupling effects ã_{k,n} can be taken into account in the DML algorithm by defining Ă=M(θ). Ã(θ) and then using Ă instead of Ã to compute the values in the second look up table

ã_{k,n} of.

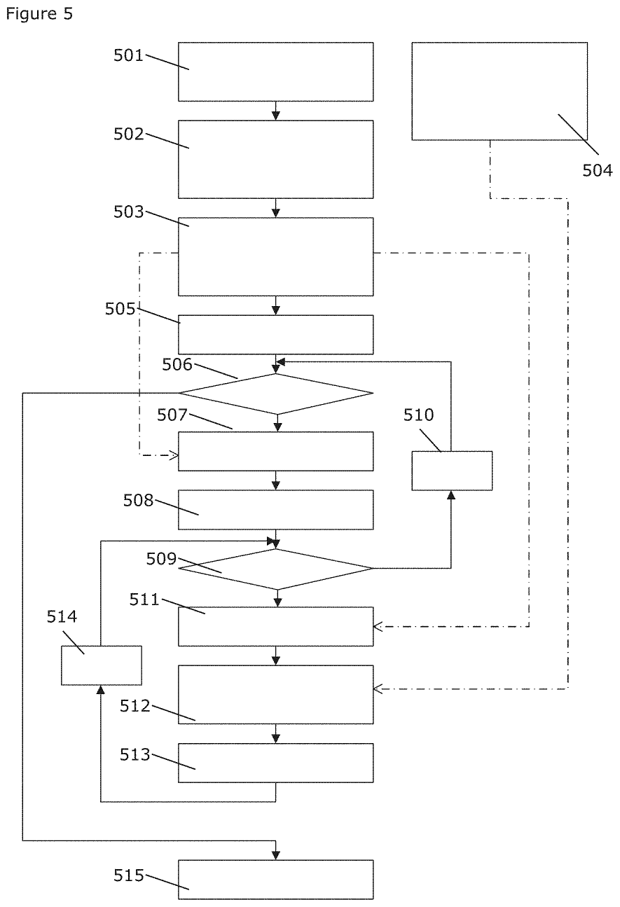

FIG. 4 shows an example computer program product 401, such as a non-transitory computer program product, comprising computer program code which, when executed by the processor 102 of the apparatus 101 causes the apparatus 101 to perform the example method of the flowchart of FIG. 5.

With reference to FIG. 5, the method generally comprises the steps of receiving 501 an input dataset, x, indicative of radar signals, x₁, . . . x_{N}, received at the plurality of antenna elements, N, wherein the radar signals have reflected from a plurality of targets, K;
defining 502 a matrix, Ã, formed of K vectors, \tilde{a}ₙ, comprising one for each one of the plurality of targets, each “beam-steering” vector \tilde{a}ₙ representing an expected response of the target represented by the “beam-steering” vector with a predetermined amplitude and comprising a function of the direction of arrival and including a factor representing antenna imperfections;
defining a signal amplitude vector s to represent expected complex amplitudes of each of the K targets as received in the radar signals;
defining an objective function based on x and Ã;
searching 505-514 for a set of directions of arrival angles for each of the targets K by the repeated evaluation of the objective function for a plurality of candidate beam-steering matrices A that each include different beam-steering vectors over a search space, wherein said set of directions of arrival are derived from one of the candidate beam-steering matrix of the plurality of candidate beam-steering matrices that provides a minimum (or maximum in other examples) evaluation of the objective function over the search space; and
wherein said search space comprises a plurality of discrete points, z, associated with the direction of arrival angles.

In particular, the method optionally comprises, at step 503, the generation of the first look up table, including wherein a dot product is computed to obtain for all k, \tilde{F}ₖ=\tilde{a}^{H}(θₖ)x.

The search using the objective function is initiated by setting an index value k to 1 at step 505. Thus, in this figure and the examples explained herein k comprises the index of the candidate DoA angle for a first target and n comprises the index of the candidate angle for the second target.

Steps 506 to 510 represent an inner loop in which the search space of N_{θ} direction of arrival angles is stepped through.

Step 506 comprises checking whether the index k is equal N_{θ} (which designates that all of the candidate direction of arrival angles of the discretized search space have been evaluated). If the condition is false, the method proceeds to step 507. If the condition is true, the method proceeds to step 515.

Step 507 comprises reading, for the current candidate direction of arrival angle, the values of \tilde{F}ₖ and |\tilde{F}ₖ|² from the first look up table generated at step 503.

Step 508 comprises setting a second index value n to equal to index value k+1.

The index value n is thus representing the candidate DoA angle of the second target.

Step 509 comprises checking whether index value n is equal to N_{θ}, that is the number of discrete direction of arrival angles in the search space.

If the condition at step 509 is true, then the method proceeds to step 510 in which the index value k is incremented by one. The method returns to step 506. If the condition of step 509 is false, the method proceeds to step 511.

Step 504 shows the generation of the second look up table. The second look up table may be generated for ã_{k,n} and, optionally, for

$$\frac{1}{N ( {\tilde{α}}_{k , k} {\tilde{α}}_{n , n} - {\vert {\tilde{α}}_{k , n} \vert}^{2} )} .$$

Step 511 comprises reading, for the current candidate direction of arrival angle, the values of \tilde{F}ₙ and |\tilde{F}ₙ|² from the first and second look up tables generated at step 503, 504.

Step 512 comprises reading, for the current n, ã_{k,n} and, optionally,

$$\frac{1}{N ( {\tilde{α}}_{k , k} {\tilde{α}}_{n , n} - {\vert {\tilde{α}}_{k , n} \vert}^{2} )}$$

from the second look up table generated at 504.

In addition, in block 512 another constant is fetched comprising one or more of ã_{k,n}, ã_{k,k} and ã_{m,n} and are substituted in

$$\frac{1}{N ( {\tilde{α}}_{k , k} {\tilde{α}}_{n , n} - {\vert {\tilde{α}}_{k , n} \vert}^{2} )} ,$$

etc, which may have been pre-calculated.

Step 513 comprises the evaluation of the objective function based on the current index value of k and n. The objective function comprises \tilde{ƒ}(k, n, x). Thus, \tilde{ƒ} is a function of the input dataset (or “snapshot”) x and of the candidate DoA angles being indexed with k and n.

The method proceeds to step 514 in which index n is incremented by one. The method returns to step 509.

Step 515 represents the completion of the search once the objective function for all of the candidate values of the search space has been evaluated. The values of θₖ (the direction of arrival angle for a first target, as defined by index k) and θₙ (the direction of arrival angle for a second target, as defined by index n) for which the objective function is maximized or minimized over the search space is thus determined.

The instructions and/or flowchart steps in the above figures can be executed in any order, unless a specific order is explicitly stated. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In one example, one or more instructions or steps discussed herein are automated. The terms automated or automatically (and like variations thereof) mean controlled operation of an apparatus, system, and/or process using computers and/or mechanical/electrical devices without the necessity of human intervention, observation, effort and/or decision.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1. An apparatus comprising a processor configured to:
receive an input dataset, x, indicative of radar signals received at a plurality of antenna elements, wherein the radar signals have reflected from a plurality of targets;
define a matrix, Ã, formed of direction-of-arrival-angle vectors, \tilde{a}ₙ, comprising one for each one of the plurality of targets, each direction-of-arrival-angle vector representing an expected response at the plurality of antenna elements of the radar signals from the target with a predetermined amplitude and comprising a function of a direction of arrival angle relative to the plurality of antenna elements and including antenna-imperfection-factors, qₚ, one for each of the plurality of antenna elements, that represent the direction-of-arrival-angle dependent effect of antenna imperfections;
define an objective function based on x and Ã;
search for a set of the direction of arrival angles for each of the plurality of targets by the repeated evaluation of the objective function for a plurality of candidate matrices based on matrix A that each include different direction-of-arrival-angle vectors over a search space, wherein said set of direction of arrival angles are derived from one of the candidate matrices of the plurality of candidate matrices that provides one of a maximum and a minimum evaluation of the objective function over the search space; and
wherein said search space comprises a plurality of discrete points associated with the direction of arrival angle.

2. The apparatus of claim 1, wherein the antenna-imperfection-factors, qₚ, comprise:
qₚ=gₚ(θₙ)e^{jh}^{ₚ}^{(θ}^{ₙ}⁾ wherein gₚ(θₙ) represents an angle dependent gain error caused by the antenna imperfections and hₚ(θₙ) represents an angle dependent phase error caused by the antenna imperfections and wherein n designates an index to step through the direction of arrival angles of the search space and wherein p comprises an index that designates each of the N antenna elements.

3. The apparatus of claim 1, wherein the apparatus is configured to, prior to said search for the set of direction of arrival angles, determine a first look up table, said first look up table providing an association between each of the plurality of discrete points of the search space and a function \tilde{F}ₖ, wherein \tilde{F}ₖ=\tilde{a}^{H}(θₖ)x and \tilde{a}^{H}(θₖ) comprises a Hermitian transpose of the direction-of-arrival-angle vector, ã, for a candidate direction of arrival angle θₖ having index k; and
wherein said search comprises a step of retrieving \tilde{F}ₖ from the look up table for each of the targets being evaluated for evaluating the objective function, wherein the objective function is based on the expression, \tilde{ƒ}:
\tilde{ƒ}=(Ã^{H}x)^{H}(Ã^{H}Ã)⁻¹(Ã^{H}x)
and \tilde{F}ₖ comprises part of the evaluation of the term (Ã^{H}x) of said expression, \tilde{ƒ}.

4. The apparatus of claim 3, wherein the apparatus is configured to determine \tilde{F}ₖ by performing a correlation comprising calculating an inner product between direction-of-arrival-angle vector, \tilde{a}, and the input dataset, x, to obtain a complex value expression, wherein the first look up table comprises the evaluation of the complex value expression over the search space.

5. The apparatus of claim 4, wherein the apparatus is configured to perform said correlation by calculation of dot products.

6. The apparatus of claim 1, wherein the direction-of-arrival-angle vectors are of the form:
\tilde{a}ₖ^{T}=(q₁e^{j2π(d}^{₁}^{/λ)sin θ}^{ₖ},q₂e^{j2π(d}^{₂}^{/λ)sin θ}^{ₖ}, . . . ,q_{N}e^{j2π(d}^{_{N}}^{/λ)sin θ}^{ₖ})
for index k and the antenna-imperfection-factors are represented by qₚ wherein p comprises an index for the plurality of antenna elements.

7. The apparatus of claim 1, wherein the apparatus is configured to, prior to said search for the set of direction of arrival angles, determine a second look up table, said second look up table providing an evaluation of ã_{k,n}=(\tilde{a}^{H}(θₖ)\tilde{a}(θₙ))/N wherein \tilde{a}^{H}(θₖ) comprises a Hermitian transpose of the direction-of-arrival-angle vector for candidate direction of arrival angle θₖ, and \tilde{a}(θₙ) comprises the direction-of-arrival-angle vector for a candidate direction of arrival angle θₙ, wherein k represents an index for each of the discrete points of the search space for a first target of the plurality of targets and n represents an index for each of the discrete points of the search space for a second target of the plurality of targets; and
wherein said search comprises a step of retrieving ã_{k,n} from the second look up table for evaluating the objective function, wherein the objective function is based on the expression, \tilde{ƒ}:
\tilde{ƒ}=(Ã^{H}x)^{H}(Ã^{H}Ã)⁻¹(Ã^{H}x)
and wherein the term (Ã^{H}Ã)⁻¹ is determined based on:
$${( {\tilde{A}}^{H} \tilde{A} )}^{- 1} = \frac{1}{N ( {\tilde{α}}_{k , k} {\tilde{α}}_{n , n} - {\vert {\tilde{α}}_{k , n} \vert}^{2} )} ( \begin{matrix}{\tilde{α}}_{n , n} & - {\tilde{α}}_{k , n}^{*} \\ - {\tilde{α}}_{k , n} & {\tilde{α}}_{k , k}\end{matrix} ) .$$

8. The apparatus of claim 7, wherein the apparatus is configured to determine the second look up table based on the properties ã_{k,n}=(ã_{n,k})*, such that the second look up table size for ã_{k,n} is ½N_{θ}(Nθ−1), wherein No designates the number of discrete points in the search space.

9. The apparatus of claim 1, wherein the objective function \tilde{ƒ} is based on \tilde{ƒ}=(Ã^{H}x)^{H}(Ã^{H}Ã)⁻¹(Ã^{H}x).

10. The apparatus of claim 1, wherein the objective function \tilde{ƒ} comprises
$$\tilde{f} = \frac{1}{N ( {\tilde{α}}_{k , k} {\tilde{α}}_{n , n} - {\vert {\tilde{α}}_{k , n} \vert}^{2} )} ( {\vert {\tilde{F}}_{k} \vert}^{2} - 2 Re \{ {\tilde{α}}_{k , n} {\tilde{F}}_{k} {\tilde{F}}_{n}^{*} \} + {\vert {\tilde{F}}_{n} \vert}^{2} )$$
wherein \tilde{F}ₖ=\tilde{a}^{H}(θₖ)x and \tilde{F}ₙ=\tilde{a}^{H}(θₙ)x, and ã_{k,n}=(\tilde{a}^{H}(θₖ)\tilde{a}(θₙ))/N, and ã_{k,k}=(\tilde{a}^{H}(θₖ)\tilde{a}(θₖ))/N, and ã_{n,n}=(\tilde{a}^{H}(θₙ)\tilde{a}(θₙ))/N.

11. The apparatus of claim 1, wherein the apparatus is configured to account for noise by application of a factor Λ^{1/2}ϕ^{T} to the matrix Ã wherein Λ is a diagonal matrix representing the spatial colouring comprising the variance of each noise component, and ϕ is the correlation between the noise components, such that the noise covariance matrix is Σ=ΛϕΛ⁻¹; wherein
the apparatus being configured to define the objective function comprises the apparatus being configured to define the objective function based on x and Λ^{1/2}φ^{T}Ã.

12. The apparatus of claim 1, wherein the apparatus is configured to account for antenna coupling effects by application of a matrix M(θ) to the matrix Ã wherein matrix M(θ) is a predetermined matrix that is indicative of the effect the excitation of one of the plurality of antenna element will have on the signal measured with another of the plurality of antenna elements; and
wherein the apparatus being configured to define the objective function comprises the apparatus being configured to define the objective function based on x and M(θ).Ã.

13. The apparatus of claim 1, wherein the apparatus includes a Range-Doppler processing module configured to separate antenna data into one or more datasets, each dataset representative of one or more targets and each dataset, relative to others of the one or more datasets, being representative of one or both of:
different ranges from the antenna elements; and
different radial velocities relative to the antenna elements; wherein
the antenna data comprises radar signals received at the plurality of antenna elements that have reflected from the plurality of targets, and wherein the input dataset, x, comprises one of said one or more datasets separated by the Range-Doppler processing module.

14. The apparatus of claim 1, wherein the apparatus comprises a frequency-modulated-continuous-wave, FMCW, radar system.

15. A method for determining the directions of arrival angles for each of a plurality of targets K in radar signals comprising:
receiving an input dataset, x, indicative of radar signals received at a plurality of antenna elements wherein the radar signals have reflected from a plurality of targets;
defining a matrix, Ã, formed of direction-of-arrival-angle vectors, \tilde{a}ₙ, comprising one for each one of the plurality of targets, each direction-of-arrival-angle vector representing an expected response at the plurality of antenna elements of the radar signals from the target with a predetermined amplitude and comprising a function of the direction of arrival angle relative to the plurality of antenna elements and including antenna-imperfection-factors, qₚ, one for each of the plurality of antenna elements, that represent the direction-of-arrival-angle dependent effect of antenna imperfections;
defining an objective function based on x and Ã;
searching for a set of directions of arrival angles for each of the plurality of targets by the repeated evaluation of the objective function for a plurality of candidate matrices based on matrix Ã that each include different direction-of-arrival-angle vectors over a search space, wherein said set of directions of arrival angles are derived from one of the candidate matrices of the plurality of candidate matrices that provides one of a maximum and minimum evaluation of the objective function over the search space; and
wherein said search space comprises a plurality of discrete points associated with the direction of arrival angles.

16. The method of claim 15, wherein the method includes the application of a matrix M(θ) to the matrix Ã wherein matrix M(θ) is a predetermined matrix that is indicative of the effect the excitation of one of the plurality of antenna element will have on the signal measured with another of the plurality of antenna elements; and
wherein the defining of the objective function comprises the defining the objective function based on the input dataset and a function of the matrix and said predetermined matrix that is indicative of the effect the excitation.

17. The method of claim 15, wherein the method includes a Range-Doppler processing to separate antenna data into one or more datasets, each dataset representative of one or more targets and each dataset, relative to others of the one or more datasets, being representative of one or both of:
different ranges from the antenna elements; and
different radial velocities relative to the antenna elements; wherein
the antenna data comprises radar signals received at the plurality of antenna elements that have reflected from the plurality of targets, and wherein the input dataset comprises one of said one or more datasets separated by the Range-Doppler processing module.

18. The method of claim 15, wherein the method includes accounting for noise by application of a factor Λ^{1/2}ϕ^{T} to the matrix wherein Λ is a diagonal matrix representing the spatial coloring comprising the variance of each noise component, and ϕ is the correlation between the noise components, such that the noise covariance matrix is Σ=ΛϕΛ⁻¹; wherein
the defining of the objective function comprises the defining the objective function based on the input dataset and a function of the matrix and said factor.

19. The method of claim 15, wherein the antenna-imperfection-factors, qₚ, comprise: qₚ=gₚ(θₙ)e^{jh}^{ₚ}^{(θ}^{ₙ}⁾ wherein gₚ(θₙ) represents an angle dependent gain error caused by the antenna imperfections and hₚ(θₙ) represents an angle dependent phase error caused by the antenna imperfections and wherein n designates an index to step through the direction of arrival angles of the search space and wherein p comprises an index that designates each of the N antenna elements.

20. The method of claim 15, further comprising prior to said searching for a set of directions of arrival angles, determining a first look up table, said first look up table providing an association between each of the plurality of discrete points of the search space and a function \tilde{F}ₖ, wherein \tilde{F}ₖ=\tilde{a}^{H}(θₖ)x and \tilde{a}^{H}(θₖ) comprises a Hermitian transpose of the direction-of-arrival-angle vector, ã, for a candidate direction of arrival angle θₖ having index k.
